(19) United States
(12) Patent Application Publication
(10) Pub. No.: US 2024/0008455 A1
(43) Pub. Date: Jan. 11, 2024

(54) INFORMATION PROCESSING DEVICE, INFORMATION PROCESSING METHOD, AND RECORDING MEDIUM

(71) Applicant: M.D.B Corporation, Tokyo (JP)

(72) Inventors: Kenji FUKUDA, Tokyo (JP); Naoki SAWADA, Tokyo (JP); Yuri SATOU, Tokyo (JP)

(73) Assignee: M.D.B Corporation, Tokyo (JP)

(21) Appl. No.: 18/029,730

(22) PCT Filed: Oct. 9, 2020
(86) PCT No.: PCT/JP2020/038314

§ 371 Date: Mar. 31, 2023

(51) Int. Cl. A01K 29/00; H04W 4/12

(52) U.S. Cl. CPC A01K 29/005; H04W 4/12

(57) ABSTRACT

The information processing device includes an information acquisition means and a messaging means. The information acquisition means acquires information related to a target animal. The messaging means transmits message information in such a manner that at least one of a content and a transmission method of the message information corresponds to a state of the target animal, when the state of the target animal determined based on the information satisfies a transmission condition of the message information set in advance.

### TECHNICAL FIELD

The present invention relates to a technique for transmitting messages related to an animal.

### BACKGROUND ART

There is a demand that pet owners want to grasp the state and behavior of pets in their home during their work and when they are is leaving home. Patent Document 1 describes a system in which a condition of a pet is detected by a sensor terminal, utterance data of a first person is generated on the basis of detection data, and conversation with the owner or other user is performed using an interactive SNS.

### PRECEDING TECHNICAL REFERENCES

### Patent Document

Patent Document 1: International Publication WO2016/125478

### SUMMARY

### Problem to be Solved by the Invention

When transmitting conversation messages based on the state of the pet as in Patent Document 1, the state and behavior of the pet serving as a trigger of the message transmission are various. Therefore, in order to enjoy a comfortable conversation with a pet, it is desired to appropriately transmit a message or the like to the owner.

One object of the present invention is to provide an information processing device capable of transmitting appropriate message information to the owner at an appropriate timing based on the state and behavior of the pet.

### Means for Solving the Problem

According to an example aspect of the present invention, there is provided an information processing device comprising:
an information acquisition means configured to acquire information related to a target animal; and
a messaging means configured to transmit message information in such a manner that at least one of a content and a transmission method of the message information corresponds to a state of the target animal, when the state of the target animal determined based on the information satisfies a transmission condition of the message information set in advance.

According to another example aspect of the present invention, there is provided an information processing method comprising:
acquiring information related to a target animal; and
transmitting message information in such a manner that at least one of a content and a transmission method of the message information corresponds to a state of the target animal, when the state of the target animal determined based on the information satisfies a transmission condition of the message information set in advance.

According to still another example aspect of the present invention, there is provided a recording medium recording a program, the program causing a computer to execute processing comprising:
acquiring information related to a target animal; and
transmitting message information in such a manner that at least one of a content and a transmission method of the message information corresponds to a state of the target animal, when the state of the target animal determined based on the information satisfies a transmission condition of the message information set in advance.

### BRIEF DESCRIPTION OF THE DRAWINGS

FIG. 1 shows an overall configuration of a communication system to which an information processing device is applied.

FIG. 2 shows an example of a floor plan of a home of an owner.

FIG. 3 is a block diagram showing a configuration of a home system.

FIG. 4 is a block diagram showing a configuration of a pet terminal.

FIGS. 5A and 5B are a block diagrams showing configurations of a server and a user terminal.

FIG. 6 is a flowchart of message information transmission processing.

FIG. 7 is an example of displaying images transmitted by the message information transmission processing.

FIG. 8 is a block diagram showing a functional configuration of the information processing device of a third example embodiment.

FIG. 9 is a flowchart of processing by the information processing device of the third example embodiment.

### EXAMPLE EMBODIMENTS

### First Example Embodiment

[Overall Configuration]

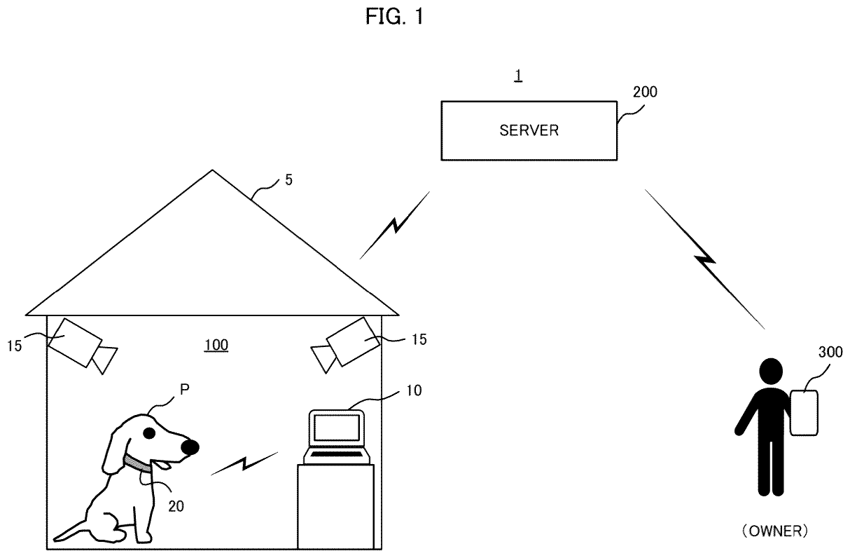

FIG. 1 shows an overall configuration of a communication system to which an information processing device according to the present disclosure is applied. The communication system 1 includes a home system 100 installed in the home 5 of the owner of the pet, a server 200, and a user terminal 300 used by the owner. The pet P is staying at the home 5 of the owner, and a pet terminal 20 is attached to the pet P. Further, fixed cameras 15 are installed in predetermined locations in the home 5. The home system 100 and the server 200 can communicate by wired or wireless communication. The server 200 can also communicate wirelessly with the user terminal 300 of the owner.

As a basic operation, the home system 100 generates message information about the pet P based on the location, behavior and state of the pet P (hereinafter referred to as the “state of the pet P”), and transmits the message information to the user terminal 300 of the owner via an interactive SNS (Social Network Service). Here, the message information includes a text message, a stamp, an image and the like. When the state of the pet P satisfies a predetermined condition (hereinafter referred to as the “transmission condition”), the server 200 transmits the message information, such as a text message, a stamp and/or an image prepared beforehand or generated in correspondence with the transmission condition, to the user terminal 300 of the owner using the interactive SNS. Thus, the owner can receive the message information according to the state of the pet P and grasp the state of the pet.

The server 200 transmits the message information of appropriate contents to the owner's user terminal 300 at appropriate timing based on the state of the pet P. Specifically, when the state of the pet P satisfies a predetermined transmission condition, the server 200 transmits the message information representing the state of the pet P at that time to the user terminal 300 of the owner via an interactive SNS. The owner can see the state of the pet P by viewing the message information transmitted to the user terminal 300.

The message information generated may be based on the behavior, location, and state of Pet P. The trigger for transmitting the message information is not limited. For example, the message information may be transmitted based on the request of the owner. It is also possible to perform interactive conversation such that the owner sends the image or message to the pet P and the pet P returns the image or message or stamp to the owner. For example, when the owner sends the message “Did you have a meal?”, the Pet P returns the image of the rice and the stamp.

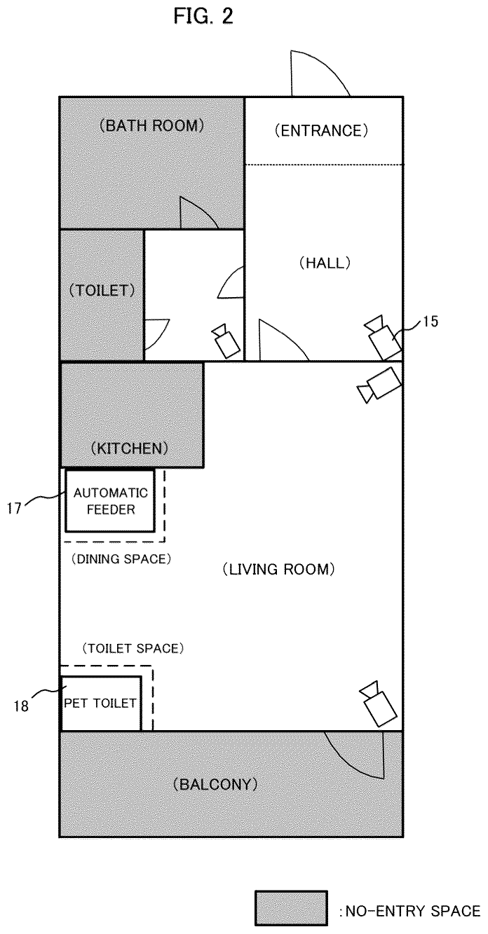

FIG. 2 shows an example of a floor plan of the owner's home 5. The home has an entrance, hall, bathroom, toilet, living room, kitchen, balcony, etc. The door partitioning each space is basically open, and the pet can move each space freely. In each space, a fixed camera 15 for capturing the state of the pet P is installed. Some of the spaces in the home 5 are decided to be the spaces where the pet P should not enter (hereinafter referred to as “no-entry spaces”). The no-entry spaces include a space to which the entry is not allowed because it is dangerous for the pet P, and a space to which the entry is not allowed because the pet P may do mischief. In the example of FIG. 2, the bathroom, toilet, kitchen, and balcony shown in gray color are determined as the no-entry spaces.

[Home System]

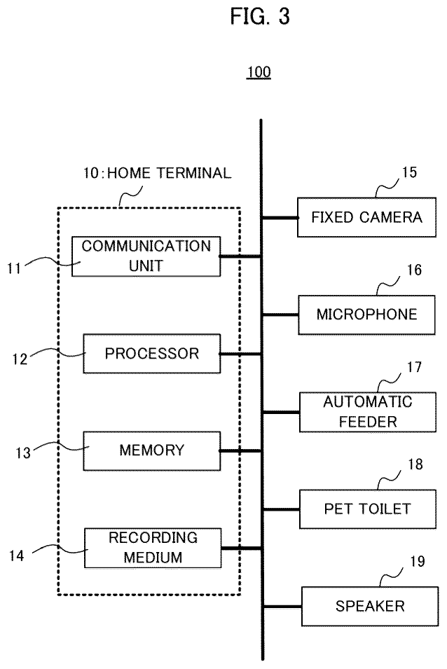

FIG. 3 is a block diagram showing the configuration of the home system 100 installed in the home 5. In the example of FIG. 3, the home system 100 includes a home terminal 10, fixed cameras 15, a microphone 16, an automatic feeder 17, a pet toilet 18, and a speaker 19. However, the home system 100 may include, not all of the above-described elements, but some of them. The home terminal 10 is, for example, a terminal device such as a PC, a tablet, or a smartphone, and includes a communication unit 11, a processor 12, a memory 13, and a recording medium 14.

The communication unit 11 communicates with an external device. Specifically, the communication unit 11 wirelessly communicates with the pet terminal 20 attached to the pet P by Bluetooth (registered trademark), for example. The communication unit 11 communicates with the server 200 in a wired or wireless manner.

The processor 12 is a computer such as a CPU (Central Processing Unit) and controls the entire home terminal 10 by executing a program prepared in advance. The processor 12 may be a GPU (Graphics Processing Unit), a FPGA (Field-Programmable Gate Array), a DSP (Demand-Side Platform), an ASIC (Application Specific Integrated Circuit), or the like. The processor 12 executes image transmission processing described later by executing a program prepared in advance. Also, the processor 12 receives the message information that the owner transmitted from the user terminal 300.

The memory 13 may be a ROM (Read Only Memory) and a RAM (Random Access Memory). The memory 13 stores various programs executed by the processor 12. The memory 13 is also used as a working memory during various processes performed by the processor 12.

The recording medium 14 is a non-volatile and non-transitory recording medium such as a disk-like recording medium and a semiconductor memory, and is configured to be detachable from the home terminal 10. The recording medium 14 records various programs executed by the processor 12. When the home terminal 10 transmits information and images related to the pet P to the server 200, the program recorded on the recording medium 14 is loaded into the memory 13 and executed by the processor 12. The images captured by the fixed cameras 15, the sound collected by the microphone 16, information received from the pet terminal 20, and the like are temporarily stored in the memory 13.

The fixed cameras 15 are installed at predetermined positions in the home 5. Basically, the necessary number of fixed cameras 15 are installed so as to cover the entire spaces in which the pet P can move. In particular, the fixed cameras 15 are installed at the positions to shoot the images of the areas including the no-entry spaces of the pet P. The fixed cameras 15 are always operating to shoot a video of the shooting range, and transmit the video the home terminal 10.

The microphone 16 is installed in each space of the home 5. The microphone 16 may be integrated with the fixed camera 15. The microphone 16 collects the sound generated in each space, and transmits the sound to the home terminal 10. The home terminal 10 transmits the sound collected by the microphone 16 to the server 200.

The automatic feeder 17 is provided in the dining space in the living room as shown in FIG. 2. The automatic feeder 17 is a device to feed the pet P when the owner is absent. For example, the automatic feeder 17 automatically supplies the feed to the dish for pet at a time set in advance, and transmits a notice indicating that the feed was given to the pet P to the home terminal 10. The home terminal 10 transmits the notice from the automatic feeder 17 to the server 200. The home terminal 10 also transmits, to the server 200, the image captured by the fixed camera around the time of receiving the notice.

The pet toilet 18 is installed in the toilet space in the living room as shown in FIG. 2. The pet toilet 18 includes, for example, a water absorbing sheet and a sensor, detects excretion of the pet P, and sends a notice to the home terminal 10. The home terminal 10 transmits the notice from the pet toilet 18 to the server 200. The home terminal 10 also transmits, to the server 200, the image captured by the fixed camera 15 around the time of receiving the notice.

The speaker 19 is installed in the living room or the no-entry space of the home 5, and outputs a warning sound and a message for the pet P. For example, by recording a scolding voice of the owner (“Don't enter there!”) in advance, the same voice can be outputted to the pet when the pet P enters the no-entry space, even when the owner is not present.

[Pet Terminal]

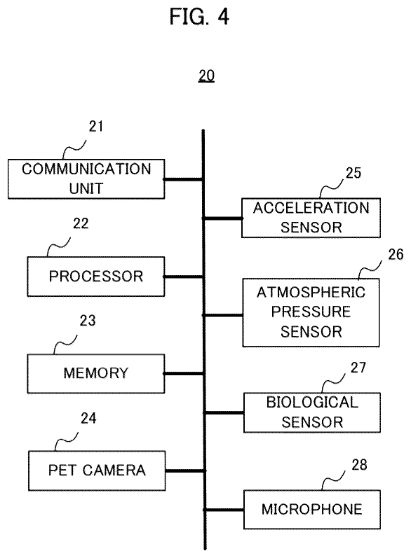

FIG. 4 is a block diagram showing the configuration of the pet terminal 20 attached to the pet P. The pet terminal 20 may be attached to the pet instead of the collar of the pet P or attached to the collar that the pet is wearing, for example. The pet terminal 20 includes a communication unit 21, a processor 22, a memory 23, a pet camera 24, an acceleration sensor 25, an atmospheric pressure sensor 26, a biological sensor 27, and a microphone 28.

The communication unit 21 communicates with an external device. Specifically, the communication unit 21 wirelessly communicates with the home terminal 10 by Bluetooth (registered trademark), for example.

The processor 22 is a computer, such as a CPU, that controls the entire pet terminal 20 by executing a predetermined program. The processor 12 periodically transmits the information acquired by each sensor to the home terminal 10 by executing a program prepared in advance.

The memory 23 is configured by a ROM, RAM or the like. The memory 23 stores various programs executed by the processor 22. The memory 23 is also used as a working memory during various processes executed by the processor 22. Furthermore, the memory 23 temporarily stores information detected by each sensor.

The pet camera 24 is a camera for shooting the image of the pet′ view. The pet camera 24 may be configured to detect the orientation of the neck of the pet P to determine the shooting direction, may be mounted near the head of the pet P, or may be a camera that shoots the front of the pet P at a wide angle. The pet camera 24 shoots an area including the viewing direction of the pet P and transmits the shot image to the home terminal 10. Thus, the home terminal 10 can acquire the image of the pet's view.

The acceleration sensor 25 is a three-axis acceleration sensor, which measures the motion of the pet P in the three-axis direction and transmits it to the home terminal 10. Based on the output of the acceleration sensor 25, the home terminal 10 can estimate the activity amount of the pet P or the like. The atmospheric pressure sensor 26 measures the atmospheric pressure at the place of the pet P and transmits it to the home terminal 10. Based on the output of the atmospheric pressure sensor 26, the home terminal 10 can detect the vertical movement of the pet P, e.g., a jump. Further, although not shown in FIG. 4, a gyro sensor may be used. A six-axis sensor in which a three-axis acceleration sensor and a three-axis gyro sensor (a three-axis angular velocity sensor) are integrated may be used. The sensor is not limited to the above-described one as long as the sensor can measure the activity amount of the animal.

The biological sensor 27 is a sensor for measuring the biological information of the pet P. For example, the biological sensor 27 measures the body temperature, the heart rate and the respiration rate of the pet P, and transmits them to the home terminal 10. The home terminal 10 transmits the acquired biological information to the server 200.

The microphone 28 collects the sound around the pet P and transmits the sound to the home terminal 10. The home terminal 10 transmits the collected sound to the server 200. The server 200 can estimate the state of the pet, e.g., the pet P is crying or barking, based on the received sound. The server 200 can estimate the motion state, the mental state, or the like of the pet based on the sound of the pet P running around or the breath sound, for example.

[Server]

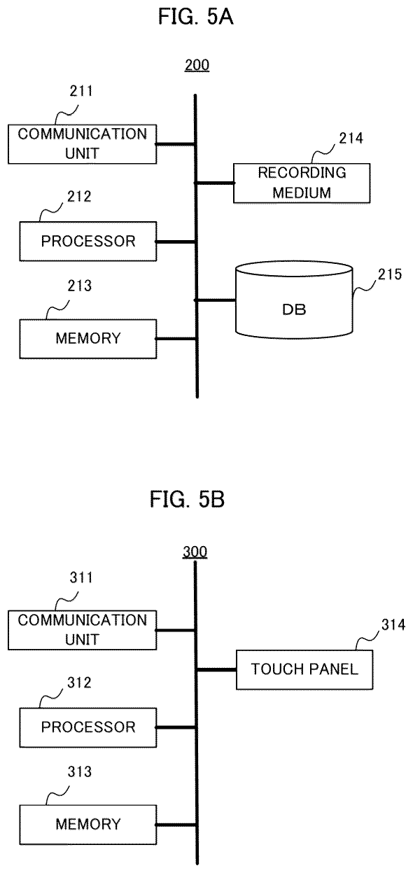

FIG. 5A is a block diagram illustrating the configuration of the server 200. The server 200 transmits messages to and receives messages from the user terminal 300 by the interactive SNS. The server 200 includes a communication unit 211, a processor 212, a memory 213, a recording medium 214, and a database 215.

The communication unit 211 transmits and receives data to and from an external device. Specifically, the communication unit 211 transmits and receives information to and from the home terminal 10 and the user terminal 300 of the owner.

The processor 212 is a computer, such as a CPU, that controls the entire servers 200 by executing a program prepared in advance. The processor 212 may be a GPU, a FPGA, a DSP, an ASIC or the like. Specifically, the processor 212 transmits message information to the owner's user terminal 300 by the interactive SNS.

The memory 213 is configured by a ROM, RAM, or the like. The memory 213 is also used as a working memory during various processes by the processor 212. The recording medium 214 is a non-volatile and non-transitory recording medium such as a disk-like recording medium or a semiconductor memory and is configured to be detachable from the server 200. The recording medium 214 records various programs executed by the processor 212.

The database 215 stores information and images received from the home terminal 10 through the communication unit 211. That is, message information and images transmitted and received by users of a plurality of terminals including the home terminal 10 and the user terminals 300 are stored in the database 215. Further, the database 215 stores, for each user, the transmission condition of the message information, and the message information prepared in advance for each transmission condition (e.g., a predetermined message, stamp, etc.). The server 200 may include a keyboard, an input unit such as a mouse, and a display unit such as a liquid crystal display to allow an administrator to give instructions or input.

[User Terminal]

FIG. 5B is a block diagram illustrating an internal configuration of the user terminal 300 used by the owner. The user terminal 300 is, for example, a smartphone, a tablet, a PC, or the like. The user terminal 300 includes a communication unit 311, a processor 312, a memory 313, and a touch panel 314.

The communication unit 311 transmits and receives data to and from the external device. Specifically, the communication unit 311 transmits and receives information to and from the server 200.

The processor 312 is a computer, such as a CPU, and controls the entire user terminal 300 by executing a program prepared in advance. The processor 312 may be a GPU, a FPGA, a DSP, an ASIC or the like. Specifically, the user terminal 300 is installed with a messaging application for the interactive SNS executed by the server 200. The “messaging application” is an application that enables exchange of information such as text messages, stamps, images and video. The processor 312 receives the transmitted message information and images through the server 200 by the messaging application and displays them on the touch panel 314. The processor 312 also transmits the message information entered by the owner to the server 200 through the messaging application.

The memory 313 is configured by a ROM and a RAM. The memory 313 is also used as a working memory during various processing by the processor 312. The touch panel 314 displays the message information received by the user terminal 300. The touch panel 314 also functions as an input device of a user.

[Message Information Transmission Control]

Next, the transmission of message information to the user terminal 300 of the owner will be described. In the present example embodiment, the server 200 performs the control of transmitting the message information of appropriate contents to the user terminal 300 of the owner based on the state of the pet P at an appropriate timing. Specific examples will be described below.

[1] Transmission of Information on the State with Emergency

The server 200 transmits the message information on the state with emergency (hereinafter, referred to as an “emergency state”) as follows in real time.

(1) Health State of Pet P

The server 200 transmits information indicating the health state of the pet P in real time if it corresponds to a predetermined emergency state. The term “real time” means that the data is transmitted as quickly as possible in the processing of the server 200 without delay from the time when the state is detected. Specifically, if the server 200 presumes that the pet P is vomiting, going into convulsions, having fever, painfully crying, entering a narrow space and becoming incapable of moving on the basis of the biometric information, the sound, the image, or the like transmitted from the home terminal 10, the server 200 transmits the message information to the user terminal 300 of the owner in real time. As to vomiting, convulsions or crying, the message information may be transmitted when the state occurs repeatedly for a predetermined time, not only once.

In this case, as the message information, a text message indicating the presumed situation, e.g. “John is vomiting!” (“John” is the name of the pet), is transmitted. Also, particularly in the case of vomiting, the server 200 may include and transmit information about the location where the pet P vomited in the message information. If there is an image at that time, the image may be transmitted as the message information. In addition, if the pet P vomited multiple times, the number of times and the locations of vomiting may be included in the message information and transmitted. For example, when the body temperature can be detected by an infrared sensor or the like, the server 200 may transmit the message information such as “John has a fever!” when the body temperature over a predetermined temperature is detected.

For the emergency state, the content of the message information may be changed according to its degree (urgency, importance, severity, etc.). For example, the server 200 may transmit only messages at normal severity, and transmit images or include alert in the message information if the severity is high.

(2) Abnormality in the Home

When the server 200 presumes that something is abnormal in the home where the pet P stays based on various information transmitted from the home terminal 10, the server 200 transmits the message information to the user terminal 300 of the owner as an emergency state. Specifically, if a family member, such as an elderly, who is in a family with the pet P collapses, the server 200 transmits the message information such as “Grandfather is collapsing!” and the like. If there is an image showing the state, the server 200 may also transmit the image as the message information.

As another example, if it is presumed that someone has comes to the house based on the sound, images, or else of the home interphone, the server 200 may transmit the message information such as “someone has come.” In this case, if there is an image of the interphone, the server 200 may also transmit the image as the message information. In addition, if it is presumed that someone is in the house while the owner is absent and the house should only have a pet, the server 200 may transmit the message information such as “someone is in the house!”. Also, the server 200 may transmit an image of an suspicious person who is in the house.

As described above, the emergency state includes at least one of the following: deterioration of the health condition of the pet, such as vomiting, convulsions, and fever; abnormal behavior of the pet, such as keeping on barking for a predetermined time or more; abnormal occurrence of a person such as an elderly falling over in the home of the owner; and abnormality in the house of the owner, such as intrusion of a suspicious person.

[2] Transmission of Daily Information of Pet

The server 200 transmits the message information about the daily state and behavior of the pet P at an appropriate timing according to its contents. Since these information have no emergency, it is not basically necessary to transmit them in real time.

(1) Information to be Transmitted at Normal Timing

The server 200 transmits the message information based on actions, e.g., at the time when the pet P wakes up in the morning, goes to bed, takes a nap, etc. For example, when the pet P wakes up, the server 200 transmits the message information such as “Good Morning!” to the user terminal 300. When the pet P takes a nap, the server 200 transmits the message information such as “I took a nap.” to the user terminal 300. When the pet P goes to bed at night, the server 200 transmits the message information such as “Good Night.” to the user terminal 300. Instead of or in addition to the text message described above, a stamp or image showing the state that the pet P is sleeping or waiting for the owner at the entrance may be transmitted as the message information.

Also, the server 200 transmits the message information about actions other than the daily routine actions of the pet P. For example, if the pet P enters an area where the pet P should not enter, the server 200 transmits the message information such as “I entered the kitchen.” and “I did mischief.”

Since these information do not have emergency, the server 200 transmits the information with the standard delay time caused by the processing of the server 200 from the time when the state is detected.

(2) Surprise Message

Rather than transmitting the message information about a specific action of the pet P, the server 200 may transmit the message information of a surprise message randomly, regardless of the action of the pet P. For example, the server 200 may transmit the message information such as “Good weather today.” in a good weather day. The server 200 may also transmit the associated message information on a particular anniversary. For example, the server 200 may transmit the message information such as “Happy Birthday!” on the owner's birthday.

As described above, the transmission condition may include at least one of the situation that the pet P becomes a specific state at a specific time period and the situation that a specific event occurs at a specific time period. That is, the server 200 may transmit the message information when the state of the pet P satisfies the transmission condition related to at least one of the situation that the pet P is in a specific state at a specific time period and the situation that a specific event occurs at a specific time period.

[3] Selection of Information to be Transmitted

If the state of the pet P satisfies multiple transmission conditions, i.e., if multiple message information to be transmitted occur, the server 200 preferably reduces the number and transmits an appropriate number of message information, instead of transmitting all of them. Therefore, the server 200 selects the message information to be transmitted in the following viewpoints.

(1) Restriction of Time Zone

When the same state or behavior of the pet P satisfies the transmission condition multiple times, the server 200 may transmit the message information only when the state or behavior of the pet P satisfies the transmission condition in a predetermined time zone. For example, since dogs sleep and rise frequently during daytime when the owner is not at home, and if the message information is transmitted each time, the message information transmitted to the owner becomes too much. Therefore, the server 200 may transmit the message information only when a predetermined state is detected in a predetermined time zone.

For example, when the pet P wakes up between 6:00 and 8:00, the server 200 transmits the message information such as “Good Morning!” to the user terminal 300. When the pet P repeatedly sleeps and rises between 14:00 and 16:00, the server 200 transmits the message information such as “I had a nap” to the user terminal 300. When the pet P goes to bed after 21:00, the server 200 transmits the message information such as “Good Night.” to the user terminal 300. In addition, when the pet P is near the entrance in the time zone when the owner usually returns home from the job, the server 200 may transmit the message information such as “Come home early.”. Thus, the server 200 may transmit the message information when the state of the pet P satisfies the transmission condition that restricts the time zone for transmitting the message information.

(2) Control of Transmission Frequency

When the same state or behavior of the pet P satisfies the transmission condition multiple times, the server 200 may restrict the frequency of transmitting the message information, instead of restricting the time zone. For example, the server 200 may determine not to transmit the same message information successively or more than three times a day. Also, the owner may set the transmission interval of the message information from the server 200 in advance. For example, if the owner sets the transmission interval to 1 hour, the server 200 transmits the message information and then transmits the next message information more than an hour later. This prevents the same message information from being transmitted repeatedly in a short time. In this case, the message information with emergency as described above is excluded. Thus, the server 200 may transmit the message information at a predetermined frequency when the state of the pet P satisfies the transmission condition of the message information multiple times.

(3) Changing Message Information

Alternatively, when the same state or behavior of the pet P satisfies the transmission condition multiple times, the server 200 may transmit different message information, instead of limiting the number of transmissions or setting the transmission interval. This prevents similar message information from being transmitted repeatedly in a short time. For example, if the pet P frequently urinates, the server 200 may change the content of the message information to be transmitted, such as transmitting a text message at the first time, transmitting a stamp at the second time, and transmitting an image at the third time. Even when the same text message is transmitted, a message with a different expression can be transmitted. In this way, when the same state of the pet P satisfies the transmission condition of the message information multiple times, the server 200 may transmit the message information of different contents multiple times.

(4) Giving Priority

When multiple states the pet P satisfy the transmission conditions at the same time or within a predetermined time, the server 200 may select the message information to be transmitted based on the priority. As the priority, the information related to the emergency state described above has the highest priority, and the priority of other information may be set in advance by the owner. For example, the owner sets priority order in advance for the message information about the meal of the pet, the message information about the urination and the defecation, the message information about the staying place of the pet, the surprise message, and the like. When multiple message information among the above occur, the server 200 may select the message information according to the priority order set by the owner and transmit the message information to the user terminal 300. Thus, the server 200 may transmit the message information according to the priority order of the plurality of transmission conditions when the state of the pet P satisfies the plurality of transmission conditions.

(5) Setting Transmittable Time Zone

The owner may set at least one of the time zone in which the message information is transmitted (hereinafter referred to as “transmission permitted time zone” or “transmittable time zone”) and the time zone in which transmission is inhibited (hereinafter referred to as “transmission inhibited time zone” or “non-transmittable time zone”) in advance. In this case, the server 200 transmits the message information only when the state of the pet P satisfies the transmission condition at the set time zone. In this case, it is noted that the message information with emergency as described above may be excluded. In this way, when the state of the pet P satisfies the transmission condition, the server 200 may transmit the message information based on whether or not it is in the transmittable time zone or the non-transmittable time zone.

When the state of the pet P satisfies the transmission condition, the server 200 may transmit the message information regardless of the time zone. However, in that case, it is assumed that the server 200 is set not to notify the reception of the message information to the user terminal 300.

[4] Transmitting Message Information According to the Owner

The server 200 may change the message information to be transmitted depending on the attribute of the owner. The attribute of the owner include the character, gender and age of the owner, and the number of years the owner has a pet. In the server 200, the attribute of the owner and the corresponding information such as the transmission frequency of the message information and the contents or type of the message information to be transmitted are prepared in advance. Incidentally, the corresponding information may be generated in advance based on, for example, a questionnaire result for a large number of pet lovers. The owner sets his or her own attribute information and stores it on the server 200. The server 200 transmits the message information by changing the transmission frequency, contents, type, and the like based on the attribute information set by the owner. For example, the server 200 may transmit the message information more frequently if the owner is a worrier, and transmit the message information less frequently if the owner tends to leave the pet unattended.

Thus, when the state of the pet P satisfies the transmission condition, the server 200 may transmit the message information based on the attribute of the owner of the pet P. Also, when the state of the pet P satisfies the transmission condition, the server 200 may transmit the message information of the content according to the attribute of the owner of the pet P. Further, when the state of the pet P satisfies the transmission condition, the server 200 may transmit the message information by a transmission method according to the attribute of the owner of the pet P (for example, a transmission frequency according to the attribute of the owner).

The server 200 initially controls the transmission of the message information based on the attribute set by the owner itself. However, when the communication of the message information with the pet P is performed to some extent using the interactive SNS, the server 200 may presume the content, type, and the transmission frequency of the message information desired by the owner based on the history of the message information transmitted to the pet P, and may transmit the message information in accordance with the owner's desires. For example, the servers 200 may control the frequency of transmitting the message information depending the frequency that the owner uses the interactive SNS. For example, if the owner is an infrequent user who uses the interactive SNS only once or twice a day, the server 200 reduces the transmission frequency of the message information depending on the owner's frequency of use. On the other hand, if the owner is a frequent user who frequently uses the interactive SNS, the servers 200 increases the frequency of transmitting the message information according to the owner's frequency of use.

[5] Sending Message Information According to Pets

The server 200 may change the message information transmitted to the owner according to an attribute or character of the pet. Specifically, the attribute of the pet include the type of the pet (e.g., dogs, cats, bees, hamsters, birds, etc.), variety of the pet, age, gender, and character. The character of the pet may be guessed based on the type, gender or age of the pet, or may be preset by the owner. For example, dogs are relatively obedient to their owners, cats are capricious, and Chihuahuas are smaller in size but have a strong character.

For example, the server 200 may increase the frequency of transmitting the message information in the case where the pet P is a child or elderly, as compared to the case where the pet P is a normal adult age. In addition, the tone of the message may be changed according to the type, age, or character of the pet P. For example, the server 200 may transmit the message information such as “Aren't you going home yet?” when the pet P having a gentle character is waiting for the owner's return, and may transmit the message information such as “Come back soon!” when the pet P has a strong character.

As the actual processing, the owner registers the attribute or character of the pet P in the server 200. For each type of pet, the server 200 stores in advance the correspondence information between the transmission frequency, the contents and the type of the message information and the attribute or the character of the pet, and transmits the message information by changing the message information based on the attribute or the character of the pet P set by the owner. The server 200 may also transmit a stamp corresponding to a set pet type. For example, if the pet P is a poodle, an illustration of the poodle may be transmitted as a stamp.

As described above, when the state of the pet P satisfies the transmission condition, the server 200 may transmit the message information based on the attribute of the pet P. Further, the server 200 may transmit the message information of the contents corresponding to the attribute of the pet P when the state of the pet P satisfies the transmission condition. Further, the server 200 may transmit the message information by a transmission method according to the attribute of the pet P (e.g., tone, tone of words, and transmission frequency according to the attribute of the pet) when the state of the pet P satisfies the transmission condition.

[6] Advice on Problematic Behavior of Pet

If it is assumed that the pet P is performing a problematic behavior based on information transmitted from the home terminal 10, the server 200 may transmit, to the user terminal 300, information related to the problematic behavior such as a description of the problematic behavior and a countermeasure. For example, it is said that dogs tend to turn the tail when they are stressful. Therefore, when a dog as the pet P is turning the tail, the server 200 may transmit, to the user terminal 300, the link information such as an article on the Web, an explanation image on the Web, a movie, a sales site of the book on the dog's behavior, or the like that explains the reason why the dog takes such an action, a remedy, or the like. In this manner, if the state of the pet P satisfies the transmission condition for the problematic behavior of the pet, the server 200 may transmit the link data of the Web site regarding the problematic behavior.

(Image Transmission Processing)

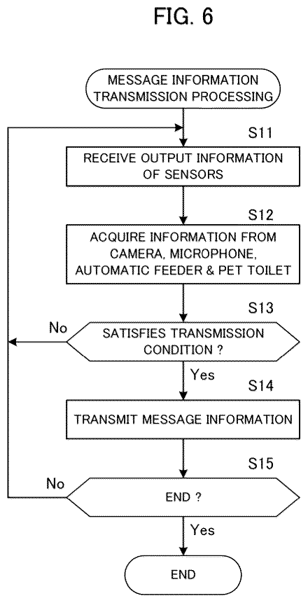

FIG. 6 is a flowchart illustrating message information transmission processing executed by the server 200. This processing is realized by the processor 212 shown in FIG. 5 which executes a program prepared in advance.

First, the server 200 receives, from the home terminal 10, the output information of the sensors (e.g., camera) provided in the room or on the pet terminal attached to the pet P (step S11). Also, the server 200 acquires information obtained by the fixed cameras 15, the microphone 16, the automatic feeder 17, and the pet toilet 18 installed in the home 5 from the home terminal 10 (step S12).

Next, the server 200 estimates the state of the pet P based on the information acquired in steps S11 and S12, and determines whether or not the state of the pet P satisfies a predetermined transmission condition (step S13). The transmission condition here is the condition for controlling the transmission of the message information. For example, if the message information based on the state of the pet P has the emergency, it immediately satisfies the transmission condition. On the other hand, if the message information based on the state of the pet P is set to be transmitted only in a predetermined time zone, it satisfies the transmission condition only in the predetermined time zone. Also, if the transmission frequency or the number of times of transmission is restricted for the message information based on the pet P, it satisfies the transmission condition only within the range of the restriction. When the state of the pet P does not satisfy the image transmission condition (step S13: No), the processing returns to step S11.

On the other hand, when the state of the pet P satisfies the transmission condition (step S13: Yes), the server 200 transmits the message information to the user terminal 300 (step S14). Thus, the message information generated based on the state of the pet P is transmitted to the user terminal 300.

Next, the server 200 determines whether or not to end the message information transmission processing (step S15). Normally, the owner operates the user terminal 300 to turn on the message information transmission processing by the server 200 when he or she leaves home, and operates the user terminal 300 to turn off the message information transmission processing when he or she comes back home. Therefore, the message information transmission processing continues until the owner turns off the message information transmission processing, and when the owner turns off the message information transmission processing (step S15: Yes), the message information transmission processing ends.

Note that the processing in step S15 is not limited to the above. For example, the server 200 may set the transmission condition so as not to transmit the message information when it determines that the owner is at home based on the position information or other information of the user terminal 300. Specifically, the server 200 determines whether or not the owner is at home based on the positional information of the user terminal 300, and sets the transmission condition not to transmit the message information when it is determined that the owner is at home. Incidentally, the position of the owner can be acquired by a GPS, for example. Further, the server 200 may determine that the owner is at home based on the connection of the user terminal 300 to the Wi-Fi communication of the home, and may set the transmission condition not to transmit the message information when it is determined that the owner is at home.

### Examples of Message Information

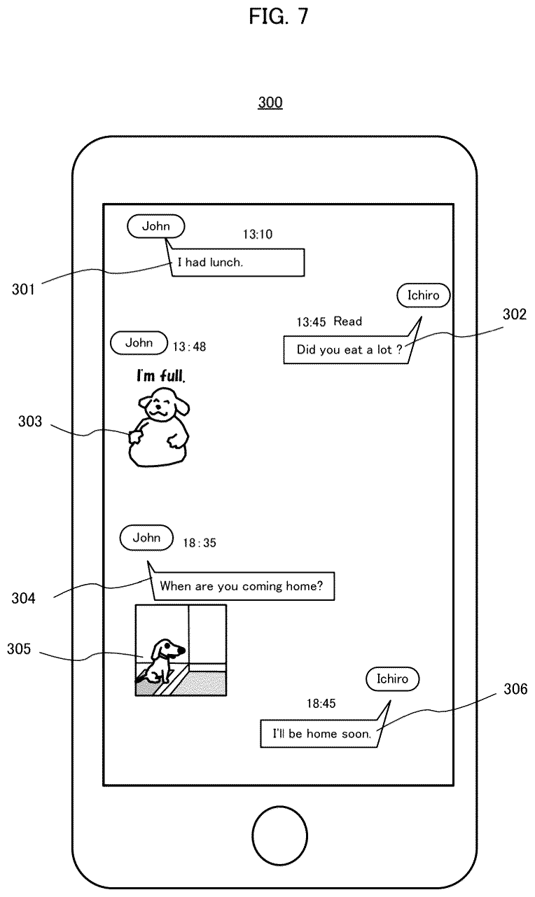

FIG. 7 shows a display example of the message information transmitted by the message information transmission processing. In this example, the user terminal 300 of the owner is displaying the message information, specifically the text message, stamp and image transmitted from the server 200 through the interactive SNS. It is assumed that the name of the owner is “Ichiro” and the name of the pet P is “John”. Also, in this example, it is assumed that the behavior of the pet P entering the dining space is set as the transmission condition, and when the pet P finishes the meal, a message prepared in advance is transmitted to the user terminal 300. Therefore, as shown in FIG. 7, the user terminal 300 in which the messaging application is installed receives and displays the text message 301 at 13:10, saying “I had lunch.” The owner sees this text message and returns the text message 302 saying “Did you ate a lot?” Further, the server 200 transmits the stamp 303 including the characters “I'm full.” in response to the message 302.

In addition, in this example, one transmission condition is that the pet P has stayed at the entrance for 5 minutes or more between 17:00 and 19:00. Therefore, as illustrated in FIG. 7, the user terminal 300 in which the messaging application is installed receives and displays the text message 304 saying “When are you coming home?” and the image 305 showing the pet P waiting at the entrance at 18:35. In response, the owner transmitted the text message 306 saying “I'll be home soon.”

[Modification]

(Modification 1)

In the first example embodiment described above, basically the information acquired by various devices and the pet terminal 20 installed in the home 5 are transmitted to the server 200 as they are, and the server 200 performs a state analysis or the like to determine the state of the pet P on the basis of the information received. Instead, a part of the processing for determining the state of the pet P may be performed in the home terminal 10 and the processing result may be transmitted to the server 200. For example, the feature value extraction or the like from the images may be performed on the home terminal 10 side, and the result may be transmitted to the server 200. This reduces the communication load from the home terminal 10 to the server 200 and the processing load on the server 200.

### Second Example Embodiment

In the first example embodiment described above, the information acquired by the various devices and the pet terminal 20 installed in the home 5 are transmitted to the server 200, and the server 200 transmits the image or message information of the pet P to the user terminal 300 based on the image transmission condition or the message information transmission condition. Alternatively, the function of the server 200 may be performed by the home terminal 10 of the home system. That is, the home terminal 10 determines whether or not the image transmission condition and the message information transmission conditions are satisfied based on the information outputted from the various devices and the pet terminal 20 installed in the home 5, and transmits the image and the message information of the pet P to the user terminal 300.

In this case, the interactive SNS messaging application is installed in the home terminal 10. When the home terminal 10 determines that the state of the pet P satisfies the transmission condition, the home terminal 10 sets the owner's user terminal 300 as the destination and transmits the message information using the messaging application. The message information is transmitted to the owner's user terminal 300 by the interactive SNS of the server 200. Incidentally, except for the above points, the second example embodiment is the same as the first example embodiment.

### Third Example Embodiment

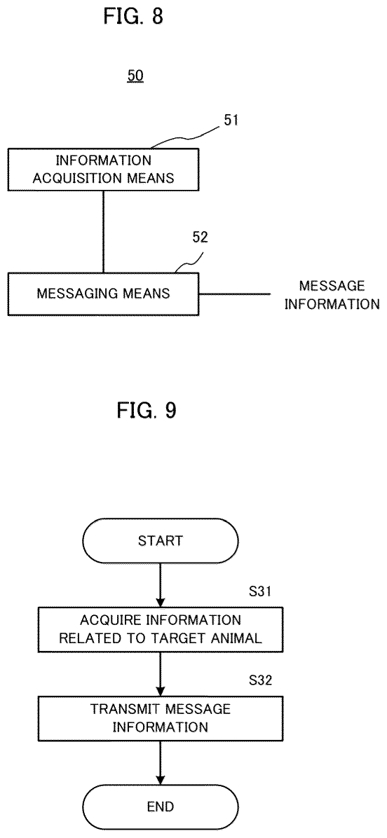

FIG. 8 is a block diagram illustrating a functional configuration of an information processing device according to a third example embodiment. The information processing device 50 according to the third example embodiment includes an information acquisition means 51 and a messaging means 52. The information acquisition means 51 acquires information related to a target animal. The messaging means 52 transmits message information in such a manner that at least one of a content and a transmission method of the message information corresponds to a state of the target animal, when the state of the target animal determined based on the information satisfies a transmission condition of the message information set in advance.

FIG. 9 is a flowchart of processing performed by the information processing device 50. The information acquisition means 51 acquires information related to a target animal (step S31). The messaging means 52 transmits message information in such a manner that at least one of a content and a transmission method of the message information corresponds to a state of the target animal, when the state of the target animal determined based on the information satisfies a transmission condition of the message information set in advance (step S32). Then, the processing ends.

According to the information processing device 50 of the third example embodiment, it is possible to transmit the message information to the owner by the content or the transmission method corresponding to the state of the target animal.

A part or all of the example embodiments described above may also be described as the following supplementary notes, but not limited thereto.

(Supplementary Note 1)

An information processing device comprising:
an information acquisition means configured to acquire information related to a target animal; and
a messaging means configured to transmit message information in such a manner that at least one of a content and a transmission method of the message information corresponds to a state of the target animal, when the state of the target animal determined based on the information satisfies a transmission condition of the message information set in advance.

(Supplementary Note 2)

The information processing device according to Supplementary note 1, wherein the messaging means transmits the message information related to a predetermined emergency state in real time, when the state of the target animal corresponds to the predetermined emergency state.

(Supplementary Note 3)

The information processing device according to Supplementary note 2, wherein the emergency state includes at least one of a deterioration of a health state of the target animal, an abnormal behavior related to the target animal, and an abnormality in a home of an owner of the target animal.

(Supplementary Note 4)

The information processing device according to Supplementary note 2 or 3, wherein the message information related to the emergency state includes link information for acquiring information related to the emergency state.

(Supplementary Note 5)

The information processing device according to Supplementary note 1, wherein the messaging means transmits the message information in real time when the state of the target animal indicates an abnormality in a place where the target animal is staying.

(Supplementary Note 6)

The information processing device according to any one of Supplementary notes 1 to 5, wherein the messaging means transmits the message information when the state of the target animal corresponds to a predetermined state in a predetermined time zone.

(Supplementary Note 7)

The information processing device according to any one of Supplementary notes 1 to 6, wherein the messaging means transmits the message information at a predetermined frequency when the states acquired over a plurality of times correspond to the same transmission condition.

(Supplementary Note 8)

The information processing device according to any one of Supplementary notes 1 to 7, wherein the messaging means transmits messages having different contents over a plurality of times, when the states acquired over the plurality of times correspond to the same transmission condition.

(Supplementary Note 9)

The information processing device according to any one of Supplementary notes 1 to 8, wherein the messaging means transmits one or more message information based on a predetermined priority order when the state of the target animal corresponds to a plurality of transmission conditions.

(Supplementary Note 10)

The information processing device according to any one of Supplementary notes 1 to 9, wherein the messaging means transmits the message information in a transmittable time zone set in advance by a user.

(Supplementary Note 11)

The information processing device according to any one of Supplementary notes 1 to 10, wherein the messaging means transmits the message information based on at least one of a content, a transmission frequency, and a transmission timing of the message information according to an attribute of the target animal.

(Supplementary Note 12)

The information processing device according to any one of Supplementary notes 1 to 11, wherein the messaging means transmits the message information based on at least one of a content, a transmission frequency, and a transmission timing of the message information according to an attribute of an owner of the target animal.

(Supplementary Note 13)

An information processing method comprising:
acquiring information related to a target animal; and
transmitting message information in such a manner that at least one of a content and a transmission method of the message information corresponds to a state of the target animal, when the state of the target animal determined based on the information satisfies a transmission condition of the message information set in advance.

(Supplementary Note 14)

A recording medium recording a program, the program causing a computer to execute processing comprising:
acquiring information related to a target animal; and
transmitting message information in such a manner that at least one of a content and a transmission method of the message information corresponds to a state of the target animal, when the state of the target animal determined based on the information satisfies a transmission condition of the message information set in advance.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

10 Home terminal
15 Fixed camera
16 Microphone
17 Automatic feeder
18 Pet toilet
19 Speaker
20 Pet terminal
24 Pet camera
27 Biological sensor
100 Home system
200 Server
300 User terminal

What is claimed is:

1. An information processing device comprising:
a memory configured to store instructions; and
one or more processors configured to execute the instructions to:
acquire information related to a target animal; and
transmit message information in such a manner that at least one of a content and a transmission method of the message information corresponds to a state of the target animal, when the state of the target animal determined based on the information satisfies a transmission condition of the message information set in advance.

2. The information processing device according to claim 1, wherein the one or more processors transmit the message information related to a predetermined emergency state in real time, when the state of the target animal corresponds to the predetermined emergency state.

3. The information processing device according to claim 2, wherein the emergency state includes at least one of a deterioration of a health state of the target animal, an abnormal behavior related to the target animal, and an abnormality in a home of an owner of the target animal.

4. The information processing device according to claim 2, wherein the message information related to the emergency state includes link information for acquiring information related to the emergency state.

5. The information processing device according to claim 1, wherein the one or more processors transmit the message information in real time when the state of the target animal indicates an abnormality in a place where the target animal is staying.

6. The information processing device according to claim 1, wherein the one or more processors transmit the message information when the state of the target animal corresponds to a predetermined state in a predetermined time zone.

7. The information processing device according to claim 1, wherein the one or more processors transmit the message information at a predetermined frequency when the states acquired over a plurality of times correspond to the same transmission condition.

8. The information processing device according to claim 1, wherein the one or more processors transmit messages having different contents over a plurality of times, when the states acquired over the plurality of times correspond to the same transmission condition.

9. The information processing device according to claim 1, wherein the one or more processors transmit one or more message information based on a predetermined priority order when the state of the target animal corresponds to a plurality of transmission conditions.

10. The information processing device according to claim 1, wherein the one or more processors transmit the message information in a transmittable time zone set in advance by a user.

11. The information processing device according to claim 1, wherein the one or more processors transmit the message information based on at least one of a content, a transmission frequency, and a transmission timing of the message information according to an attribute of the target animal.

12. The information processing device according to claim 1, wherein the one or more processors transmit the message information based on at least one of a content, a transmission frequency, and a transmission timing of the message information according to an attribute of an owner of the target animal.

13. An information processing method comprising:
acquiring information related to a target animal; and
transmitting message information in such a manner that at least one of a content and a transmission method of the message information corresponds to a state of the target animal, when the state of the target animal determined based on the information satisfies a transmission condition of the message information set in advance.

14. A non-transitory computer-readable recording medium recording a program, the program causing a computer to execute processing comprising:
acquiring information related to a target animal; and
transmitting message information in such a manner that at least one of a content and a transmission method of the message information corresponds to a state of the target animal, when the state of the target animal determined based on the information satisfies a transmission condition of the message information set in advance.
